(19) United States
(12) Patent Application Publication
(10) Pub. No.: US 2011/0202382 A1
(43) Pub. Date: Aug. 18, 2011

(54) WORKFORCE PLANNING

(76) Inventors: Cipriano A. Santos, Modesto, CA (US); Maria Teresa Gonzalez Diaz, Sunnyvale, CA (US); Shailendra K. Jain, Sunnyvale, CA (US); Xin Zhang, San Jose, CA (US); Jose Luis Beltran-Guerrero, Palo Alto, CA (US)

(21) Appl. No.: 13/125,725

(22) PCT Filed: Oct. 28, 2008
(86) PCT No.: PCT/US08/81400

§ 371 Date: Apr. 22, 2011

(51) Int. Cl. G06Q 10/00

(52) U.S. Cl. 705/7.17

(57) ABSTRACT

Systems, methods, and other embodiments associated with workforce planning. One example method includes receiving a project data associated with a project opportunity. The project data includes a probability data. The probability data describes the likelihood of a project opportunity being selected. The project data includes a workforce demand. The example method may also include establishing an objective function that is based, at least in part, on the project data, and a set of constraints. The objective function concerns a workforce allocation plan. The example method may also include minimizing a workforce cost by solving the objective function in light of the set of constraints. Solving the objective function includes optimizing a tradeoff between labor utilization and project demand fulfillment. The example method may also include providing the workforce allocation plan.

### COPYRIGHT NOTICE

A portion of the disclosure of this patent document contains material subject to copyright protection. The copyright owner has no objection to the facsimile reproduction of the patent document or the patent disclosure as it appears in the Patent and Trademark Office patent file or records, but otherwise reserves all copyright rights whatsoever.

### BACKGROUND

Businesses that manage multiple projects have workforce planning issues that involve trying to service multiple project opportunities. For example, consulting firms and temporary staffing companies may manage multiple projects and thousands of workers. These issues may involve hiring new employees, training existing employees, assigning qualified employees, and so on. Balancing the need for hiring and training workers to prevent labor shortages (e.g. gaps) against a need to prevent an over-supply of employees (e.g. gluts) during project slowdowns is a challenging task. The need to forecast the demand for workers has been problematic since the inception of workforce planning. Mathematical modeling associated with workforce planning was first utilized by the United States military in the early 1950s. These mathematical models used linear programming and mixed integer programming. The first mathematical models calculated training and logistics schedules for military personal. Typical workforce planning models borrow from the planning concepts of supply chain management. However, workforce planning models often fail to assign individuals to jobs, instead they assign groups of people by skill by matching attributes. Additionally, typical workforce planning models fail to account for training that may allow employees to satisfy skill sets for different jobs. These workforce planning models may also fail to account for the potential of future hiring to increase workforce skill sets that may be utilized to satisfy future project opportunities.

### BRIEF DESCRIPTION OF THE DRAWINGS

The accompanying drawings, which are incorporated in and constitute a part of the specification, illustrate various example systems, methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 illustrates one embodiment of an example method associated with workforce planning.

FIG. 2 illustrates one embodiment of another example method associated with workforce planning.

FIG. 3 illustrates one embodiment of another example method associated with workforce planning.

FIG. 4 illustrates one embodiment of an example system associated with workforce planning.

FIG. 5 illustrates one embodiment of an example computing environment in which example systems and methods, and equivalents, may operate.

### DETAILED DESCRIPTION

A mixed integer programming (MIP) model that includes an objective function may be utilized to generate a workforce allocation plan for a given planning horizon. A workforce allocation plan may include a labor fulfillment plan to allocate labor, a labor procurement plan for hiring, and a labor transformation plan that tracks training, promotions, re-deployment, and so on.

The objective function may be based on a project data associated with a project opportunity or multiple project opportunities. The project data may include a workforce demand for a project opportunity and a probability data that describes the likelihood of the project opportunity being selected. Additionally, the objective function may also include a set of constraints and project data. The objective function may minimize a workforce cost associated with a workforce allocation plan by solving the objective function in light of the set of constraints. Solving the objective function may include optimizing a tradeoff between labor utilization and project demand fulfillment to determine an optimized set of variables to minimize the workforce cost of the workforce allocation plan. In one example, constraints in the objective function may be associated with a penalty cost. The penalty cost reflects the cost of a violation of the constraint. A constraint that can be violated at a cost may be referred to as a “soft constraint.” A hard constraint cannot be violated and thus defines the feasible set of solutions.

The objective function may relate to a problem that seeks to minimize or maximize a real function by systematically choosing values from within an allowed set. These values may be restricted by constraints that may be equalities or inequalities that the values have to satisfy. The domain of the values is often referred to as the search space. Additionally, the objective function may model penalties or costs that may be calibrated to induce a desired behavior for resource allocation. The costs may include current and future cost of labor undersupply (e.g. gaps), cost of labor oversupply (e.g. glut), training cost, and hiring cost. These costs may be multiplied by associated variables to induce behavior. For example, the objective function may be programmed to prefer a labor oversupply (e.g. glut) as opposed to a labor undersupply (e.g. gap). This may be accomplished by assigning a higher cost associated with labor undersupply than with labor oversupply.

The objective function may also calculate an optimized equation for multiple time intervals and account for the probability of a project being selected. For example, projects with high probabilities of being selected may have higher costs/penalties for gaps and consequently have an increased probability of being staffed.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

ASIC: application specific integrated circuit.

CD: compact disk.

CD-R: CD recordable.

CD-RW: CD rewriteable.

DVD: digital versatile disk and/or digital video disk.

HTTP: hypertext transfer protocol.

LAN: local area network.

PCI: peripheral component interconnect.

PCIE: PCI express.

RAM: random access memory.

DRAM: dynamic RAM.

SRAM: static RAM.

ROM: read only memory.

PROM: programmable ROM.

EPROM: erasable PROM.

EEPROM: electrically erasable PROM.

USB: universal serial bus.

WAN: wide area network.

“Computer component”, as used herein, refers to a computer-related entity (e.g., hardware, firmware, software in execution, combinations thereof). Computer components may include, for example, a process running on a processor, a processor, an object, an executable, a thread of execution, and a computer. A computer component(s) may reside within a process and/or thread. A computer component may be localized on one computer and/or may be distributed between multiple computers.

“Computer communication”, as used herein, refers to a communication between computing devices (e.g., computer, personal digital assistant, cellular telephone) and can be, for example, a network transfer, a file transfer, an applet transfer, an email, an HTTP transfer, and so on. A computer communication can occur across, for example, a wireless system (e.g., IEEE 802.11), an Ethernet system (e.g., IEEE 802.3), a token ring system (e.g., IEEE 802.5), a LAN, a WAN, a point-to-point system, a circuit switching system, a packet switching system, and so on.

“Computer-readable medium”, as used herein, refers to a medium that stores signals, instructions and/or data. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device can read.

In some examples, “database” is used to refer to a table. In other examples, “database” may be used to refer to a set of tables. In still other examples, “database” may refer to a set of data stores and methods for accessing and/or manipulating those data stores.

“Data store”, as used herein, refers to a physical and/or logical entity that can store data. A data store may be, for example, a database, a table, a file, a list, a queue, a heap, a memory, a register, and so on. In different examples, a data store may reside in one logical and/or physical entity and/or may be distributed between two or more logical and/or physical entities.

“Logic”, as used herein, includes but is not limited to hardware, firmware, software in execution on a machine, and/or combinations of each to perform a function(s) or an action(s), and/or to cause a function or action from another logic, method, and/or system. Logic may include a software controlled microprocessor, a discrete logic (e.g., ASIC), an analog circuit, a digital circuit, a programmed logic device, a memory device containing instructions, and so on. Logic may include one or more gates, combinations of gates, or other circuit components. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, software). Logical and/or physical communication channels can be used to create an operable connection.

“Query”, as used herein, refers to a semantic construction that facilitates gathering and processing information. A query may be formulated in a database query language (e.g., SQL), an OQL, a natural language, and so on.

“Signal”, as used herein, includes but is not limited to, electrical signals, optical signals, analog signals, digital signals, data, computer instructions, processor instructions, messages, a bit, a bit stream, or other means that can be received, transmitted and/or detected.

“Software”, as used herein, includes but is not limited to, one or more executable instruction that cause a computer, processor, or other electronic device to perform functions, actions and/or behave in a desired manner. “Software” does not refer to stored instructions being claimed as stored instructions per se (e.g., a program listing). The instructions may be embodied in various forms including routines, algorithms, modules, methods, threads, and/or programs including separate applications or code from dynamically linked libraries.

“User”, as used herein, includes but is not limited to one or more persons, software, computers or other devices, or combinations of these.

Some portions of the detailed descriptions that follow are presented in terms of algorithms and symbolic representations of operations on data bits within a memory. These algorithmic descriptions and representations are used by those skilled in the art to convey the substance of their work to others. An algorithm, here and generally, is conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic, and so on. The physical manipulations create a concrete, tangible, useful, real-world result.

It has proven convenient at times, principally for reasons of common usage, to refer to these signals as bits, values, elements, symbols, characters, terms, numbers, and so on. It should be borne in mind, however, that these and similar terms are to be associated with the appropriate physical quantities and are merely convenient labels applied to these quantities. Unless specifically stated otherwise, it is appreciated that throughout the description, terms including processing, computing, determining, and so on, refer to actions and processes of a computer system, logic, processor, or similar electronic device that manipulates and transforms data represented as physical (electronic) quantities.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

An example of workforce planning may involve a hypothetical international services company with tens of thousands of employees handling hundreds of projects. The workers may deliver a wide variety of services to different customers. The annual cost of labor of this workforce may be in the billions of dollars. Workforce planning facilitates the efficient allocation of this workforce to reduce employee over supply labor costs, improve employee morale, boost productivity, and so on.

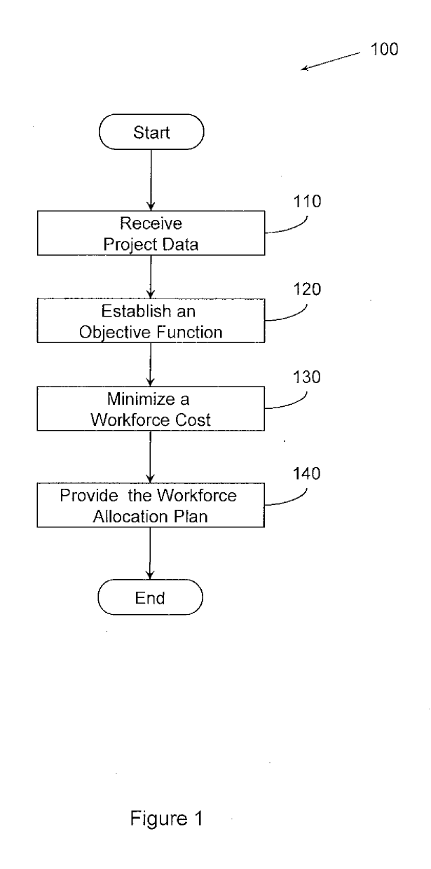

FIG. 1 illustrates a method 100 associated with workforce planning. The workforce planning may include solving a set of equations in light of a set of constraints using a mixed integer programming technique. Method 100 may include, at 110, receiving project data. The project data may be associated with multiple projects. The project data may be associated with a set of project opportunities. The project data may include a probability data. The probability data may describe the likelihood of a project opportunity being selected. For example, a salesman in the hypothetical international services company may assign a probability that a future project opportunity will actually be agreed to and performed. The project data may include a workforce demand. For example, the workforce demand may describe the demand for staff and demand for particular skill sets of the staff.

In one embodiment, the project data may include a number of jobs required by the project opportunity, a duration for a job required by the project opportunity, a probability data that describes the likelihood of employee attrition, a set of skills associated with a job of the project opportunity, and so on. In one embodiment, the set of skills includes a job management level, a job proficiency, an industry type, a job skill set, a job title, and so on. The project data may be used as a cost in an equation to be solved for a minimum cost. The project data may also be used as a constraint for a variable. Thus, the project data may describe values or constraints in a set of equations used in an MIP model.

Method 100 may also include, at 120, establishing an objective function. The objective function may be based, at least in part, on the project data, and a set of constraints. The objective function may relate to a workforce allocation plan. In one embodiment, the workforce allocation plan may include a labor transformation plan and a labor procurement plan.

In one embodiment, the labor transformation plan may include data concerning training, data concerning promotions, data concerning re-deployment, and so on. In one embodiment, the labor transformation plan includes data associated with a lead time for training an employee to attain the job skill set. In one embodiment, the labor procurement plan includes data associated with a hiring lead time for a job title. In one embodiment, the set of constraints includes, a workforce transformation constraint, a workforce buffer capacity constraint, a hiring detail constraint, an employee allocation hierarchy constraint, a job assignment constraint, and so on. Thus, the constraints may describe a set of business rules that govern the hypothetical international services company. These business rules may includes limits on hiring of total staff, limits on hiring of particular skill sets, minimum training required for staff members of different skill sets, and so on.

The set of constraints may include a workforce transformation data, a workforce buffer capacity constraint, a hiring detail data, employee allocation hierarchy constraint, job assignment constraint, and so on. The workforce transformation data may also include data to identify workers that may be trained for new skill sets. The workforce buffer capacity constraint may be a formula used to calculate the workforce buffer capacity based on the demand and supply uncertainty. Supply uncertainty may include, for example, considerations of employee attrition. Employee attrition may vary widely between installations in different parts of an organization. For example, attrition may be historically low in a first location (e.g., Des Moines, Iowa) but may be historically high in a second location (e.g., San Jose, Calif.). The hiring detail data may include new employee pipeline data, new employee limit data that may be set by skill set, and so on. The employee allocation hierarchy constraint may include gap and hiring penalties. A gap penalty may be a cost that is incurred when a project opportunity is not completely staffed. Thus, in the hypothetical international services company penalties may exist for not servicing projects.

In one embodiment, establishing the objective function includes establishing a set of costs calibrated to induce a desired resource allocation behavior. For example, the objective function may be programmed to prefer to have a labor oversupply (e.g. glut) instead of a labor undersupply (e.g. gap). This may be accomplished by assigning a higher cost associated with labor undersupply than with labor oversupply. The costs included in the objective function may encourage hiring of particular skill sets, training workers, assigning individual workers to particular projects, and so on.

The set of costs may include a cost of leaving a current gap, a cost of leaving a future gap, a training cost, a hiring cost, a cost of idle excess workforce, a workforce buffer cost, and so on. The set of costs may be calibrated to induce a desired behavior for resource allocation. The costs may include current and future cost of labor undersupply (e.g. gaps), cost of labor oversupply (e.g. glut), training cost, and hiring cost. These costs may be multiplied by associated variables to induce behavior. For example, the objective function may be programmed to prefer to have a labor oversupply (e.g. glut) instead of a labor undersupply (e.g. gap). This may be accomplished by assigning a higher cost associated with labor undersupply than with labor oversupply.

The workforce allocation plan may determine when the labor force size and/or the labor skill mix to decrease the cost of service delivery. For example, in the case of over-employment (e.g. gluts) employees will be drawing salary and benefits while a company receives no revenue from these workers. However, in the case of under-employment (e.g. gaps) a company will be unable to satisfy project demand and will also lose revenues from lost project opportunities. Costs may be assigned to over employment and under employment. Therefore, the workforce allocation plan may determine a labor size and a skill mix that is cost efficient and that optimizes the tradeoff between project demand fulfillment and labor utilization.

The objective function may minimize costs for multi-period environments and also account for the uncertainty of project opportunities. The objective function may also account for employee transitions including hiring, training, job changes, promotions, firing, attrition, and retirement. The objective function may also enable allocation of individual employees to jobs required by project opportunities.

The workforce allocation plan may be based on various business rules or constraints captured in the objective function. Variables associated with the workforce costs may be restricted by constraints that may be equalities or inequalities that the variables have to satisfy. For example, staffing level variables may be bounded by a minimum and maximum constraint. The objective function may be solved for any staffing level variable that is between the minimum and maximum constraint.

The objective function may increase billable resources utilization by increasing the number of workers and/or the percentage of the workforce allocated to projects. Additionally, the MIP may generate a workforce transformation plan indicating employees that may be trained, promoted, or re-deployed in order to satisfy current or future demand with the current workforce as opposed to hiring new employees. Typical workforce planning tools respond to workforce transformation from the supply perspective. In contrast, the objective function may trigger workforce transformation based on projects that demand labor.

In addition, there may be financial limits that constrain the ability of hiring. For example, a finite number of employees having a desired skill set may be available in a radius that would not require paying of moving expenses. Therefore, the objective function may consider constraints on the number of people to hire at different levels of aggregation. For instance, a hiring budget over the planning horizon can be defined and the cost of hiring a person qualified to perform the job may also defined. The objective function may have a hiring constraint that limits the total number of people to hire during the planning horizon based on the hiring budget and cost of hiring for a particular job. Another constraint may define the maximum total number of employees by skill set or technology to hire over the planning horizon and define an associated constraint. In some examples, to keep stability of the hiring plans within a planning cycle, a user may fix hiring plans of certain skill sets or technologies or over certain periods of time, and let the objective function update and optimize the hiring non-fixed skill set related jobs.

Method 100 may also include, at 130, minimizing a workforce cost. Minimizing a workforce cost at 130 may be performed by solving the objective function in light of the set of constraints. Solving the objective function may include optimizing a tradeoff between labor utilization and project demand fulfillment.

In one embodiment, minimizing the workforce cost includes assigning a cost to the workforce buffer capacity. The cost may be directly proportional to the time an employee has been associated with the workforce buffer capacity. The cost of the workforce buffer capacity may result in an incentive to assign employees who are included in the workforce buffer capacity over employees who are not included in the workforce buffer capacity.

In one embodiment, minimizing the workforce cost includes assigning a first, higher cost to a labor shortage, and assigning a second, lower cost to a labor oversupply. For example, the objective function may be programmed with a workforce cost to prefer a labor oversupply (e.g. glut) instead of a labor undersupply (e.g. gap). Demand may be uncertain. Thus, the cost of a gap or glut may reflect the uncertainty. For example, when the win probability of an opportunity is above a certain threshold, the cost of a gap may be higher than the cost of a glut. Conversely, when the win probability of an opportunity is below a certain threshold, the cost of a gap may be lower than the cost of a glut. In one example, labor oversupply may be preferred because it may be more expensive to lose a project due to not having staff available than over staffing. Over staffing may have positive benefits including having time to train staff. Labor oversupply preferences may be accomplished by assigning a higher cost associated with labor undersupply than with labor oversupply. In one embodiment, minimizing the workforce cost includes calculating the workforce allocation plan for multi-period environments. In one embodiment, the workforce allocation plan maps employees to jobs according to the length of time employees are associated with a workforce buffer capacity. In one embodiment, the workforce buffer capacity is an inactive status for employees that are not assigned to a project, in training, and so on.

Method 100 may also include, at 140, providing the workforce allocation plan. In one embodiment, the workforce allocation plan maps employees to jobs required by project opportunities. In one embodiment, the workforce allocation plan is provided as a signal to a workforce plan logic (WPL).

The objective function may be represented by a Resource Manager utility function expressing a Resource Manager preference to allocate supply to satisfy demand. Project opportunities may have a priority and a winning probability. Penalties associated with costs are then computed to prioritize demand based on these costs. Project opportunities with higher costs will get available resources first. The workforce buffer capacity may have the lowest cost. Therefore, the workforce buffer capacity will get resources not consumed by priority opportunities but to address uncertainty in workforce supply and demand. Penalties for workforce buffer capacity employee under supply (e.g. undersupply of employees to training) should be lower than employee under-supply penalties of project opportunities because project employee under-supply results in a loss of project revenue. However, in the case of increased demand by a future project for a skill set that requires training, the objective function may pay the penalty of an employee under supply in the short term for a small project. This may be done to avoid the penalty of idle resources in the future on a larger more profitable project.

An example utility function may be seen below.

$$Min {\sum }_{i} ( 1 - {z}_{i} ) * {oppty}_{i} * ( 1 - {honly}_{i} ) * {RL}_{i} * {\sum }_{i} ( \vert T \vert - ( t - 1 ) ) * {1}_{i , t} + {\sum }_{j , i , t} ( \vert T \vert - ( t - 1 ) ) * {winprb}_{i} * {RL}_{i} * {gap}_{j , i , t} + CT * {\sum }_{w , j , i , t} {xt}_{w , j , i , t} + CH * {\sum }_{j , i , t} {h}_{j , i , t} + CI * ( {\sum }_{j , i , t} ( {inv}_{j , i , t} - {a}_{j , i , t} ) + {\sum }_{w , t} ( {\sum }_{τ = 1}^{t} {R}_{w , τ} - {\sum }_{j , i} {x}_{w , j , i , t} ) ) + CU * {{\sum }_{w , j , i :}}_{i \neq dumy} {u}_{w , j , i} + CB * {\sum }_{w , j} {u}_{w , j , dumy}$$

This equation generally describes the cost of leaving a current gap (e.g. labor under supply), the cost of leaving a future gap, training costs, hiring costs, costs of idle excess, bench cost (e.g. workforce buffer capacity cost), and so on. Values of costs in the objective function may be calibrated to induce a desired behavior for resource allocation. The following are example costs. CU may be an average fixed cost of allocation. CB may be an average fixed cost of allocation to workforce buffer capacity. CI may be an average idle inventory cost. CT may be an average training cost. CH may be an average hiring cost. RLᵢ may be an average revenue loss for all project opportunities i including priority opportunities and the workforce buffer capacity. RLᵢ may be associated with a gap cost or the cost of not fulfilling the demand from a project opportunity. RLᵢ may include multiple time periods, with the costs varying for the different time periods. For example, costs of not filling the gap of a current time period may be more expensive than the cost of not filling the gap of a future time period.

In one example, RLᵢ>CH>CT>CB>CU. In this example, the staffing requirements will first be satisfied with available qualified employees. If employees are not available then the example systems and methods attempt to identify transitionable employees who may satisfy skill requirements. If there are no available or transitionable employees the example systems and methods will attempt to hire new employees. If the example systems and methods cannot hire due to lead time, the example systems and methods may declare a project gap due to under-employment or under-staffing.

While FIG. 1 illustrates various actions occurring in serial, it is to be appreciated that various actions illustrated in FIG. 1 could occur substantially in parallel. By way of illustration, a first process could receive a project data, a second process could establish an objective function, and a third process could minimize a workforce cost by solving the objective function. While three processes are described, it is to be appreciated that a greater and/or lesser number of processes could be employed and that lightweight processes, regular processes, threads, and other approaches could be employed.

In one example, a method may be implemented as computer executable instructions. Thus, in one example, a computer-readable medium may store computer executable instructions that if executed by a machine (e.g., processor) cause the machine to perform a method that includes one or more of, receiving a project data, establishing an objective function, minimizing a workforce cost, and providing a workforce allocation plan. While executable instructions associated with the above method are described as being stored on a computer-readable medium, it is to be appreciated that executable instructions associated with other example methods described herein may also be stored on a computer-readable medium.

In one example, data structures may be constructed that facilitate storing data on a computer-readable medium and/or in a data store. Thus, in one example, a computer-readable medium may store a data structure that includes, a first field for data associated with the probability data, a second field for data associated with the workforce demand, and a third field for data associated with objective function. With this “raw” data available, the data structure may also include a fourth field for storing a workforce allocation data that is derived from data located in one or more of the first through third fields. While four fields are described, it is to be appreciated that a greater and/or lesser number of fields could be employed.

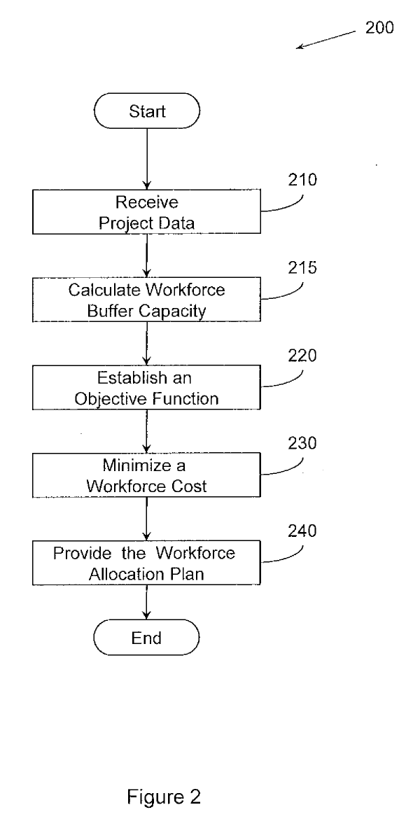

FIG. 2 illustrates a method 200 associated with workforce planning. Method 200 may include actions similar to method 100 of FIG. 1. These actions may include receiving project data at 210, establishing an objective function at 220, minimizing a workforce cost at 230, and providing the workforce allocation plan at 240.

However, method 200 may also include, at 215, calculating workforce buffer capacity. Calculating a workforce buffer capacity at 215 may facilitate dealing with supply and demand uncertainty of project opportunities. The workforce buffer capacity may vary based, at least in part, on uncertainty associated with project opportunities. For example, if a priority project of high probability is not selected, the extra staffing from the non-selected project that cannot be reassigned may be put in the workforce buffer capacity far additional training. Buffer capacity may also be used to support ongoing projects that may be under-staffed, to account for illness and other worker disruptions, and so on.

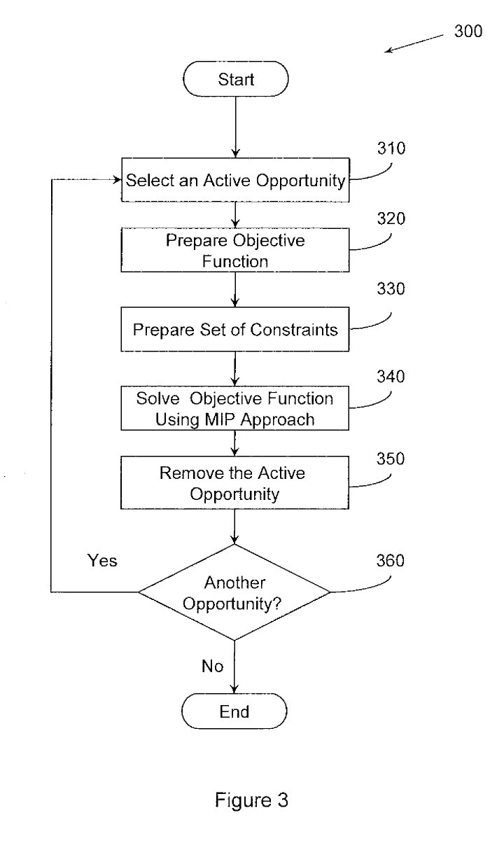

FIG. 3 illustrates a method 300 associated with workforce planning. Once again method 300 may approach workforce planning using an objective function and an MIP technique. The method 300 may formulate a single-opportunity objective function that may be solved for each priority project opportunity or a set of priority project opportunities. Priority project opportunities may include practice building (e.g. project demand fulfillment), and planned workforce buffer capacity. Practice building may not reflect real demand but may reflect a desire to retool a workforce. The workforce may be retooled, for example, to accommodate a new technology arriving in the marketplace. Thus, practice building may be treated as a special type of opportunity. Priority rules may be based on the probability of wining an opportunity in a portfolio of opportunities and the priority given to an opportunity. The portfolio of opportunities addressed by the MIP may be called active opportunities.

Method 300 may include, at 310, selecting an active opportunity. Selecting an active opportunity at 310, may include selecting the opportunity from a set of opportunities. The active opportunity may be associated with a project opportunity. In one example, the set of opportunities may be described as residing in a funnel that feeds an MIP engine.

Method 300 may also include, at 320, preparing an objective function. Preparing an objective function at 320 may be performed to facilitate calculating a minimum cost for a workforce. The objective function may be solvable to optimize a tradeoff between labor utilization and project demand fulfillment. For example, the objective function may balance the needs of hiring to staff potential projects against the need to prevent over staffing by over hiring. Thus, the tradeoff may be a balance between over hiring and under hiring.

Method 300 may also include, at 330, preparing a set of constraints. Preparing a set of constraints at 330 may facilitate later controlling the solving of the objective function. The constraints may include a cost of leaving a current gap, a cost of leaving a future gap, a training cost, a hiring cost, a cost of idle excess workforce, a workforce buffer cost, and so on.

Method 300 may also include, at 340, solving the objective function using a mixed integer programming (MIP) approach. Solving the objective function using an MIP approach at 340 may include solving the objective function for the active opportunity using an MIP approach. The MIP may be controlled by the set of constraints.

Method 300 may also include, at 350, removing the active opportunity. Removing the active opportunity at 350 may include removing it from the set of active opportunities. Since there is a set of opportunities in the funnel feeding the engine, actions performed at 310 through 350 may be repeated.

Method 300 may also include, at 360, determining if there is another opportunity. If there is another opportunity the method 300 may return to selecting an active opportunity at 310. If there is not another opportunity the method 300 may end. In one example, opportunities in the set of opportunities may be sorted to control the order in which they are processed. For example, opportunities may be sorted based on projected revenue, project profit, priority, size, length, and so on.

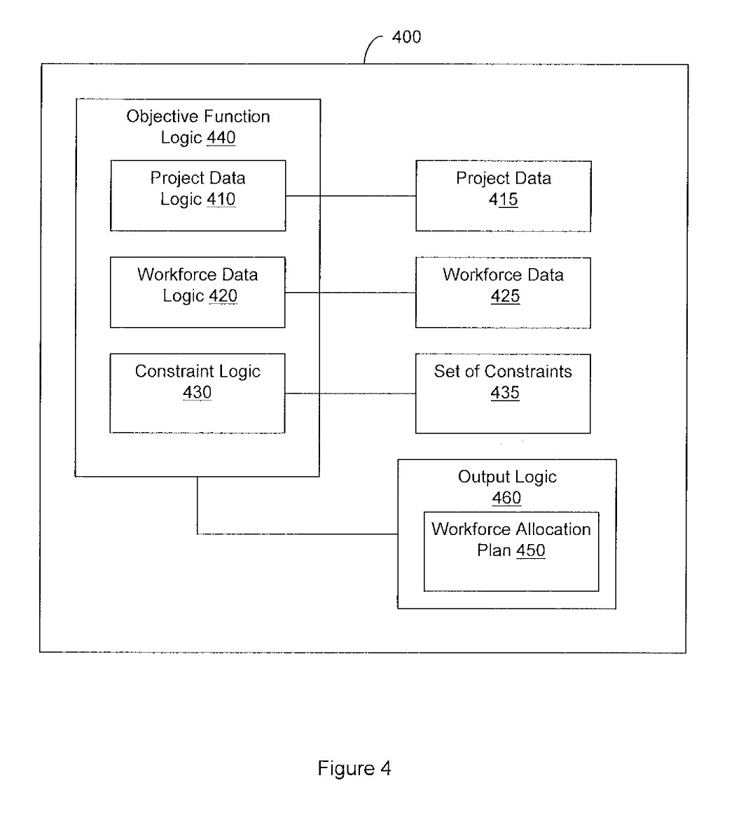

FIG. 4 illustrates a system 400 that is associated with workforce planning. System 400 includes a project data logic 410 to receive a project data 415 associated with a project opportunity. The project data 415 may include a probability data that describes the likelihood of the project opportunity being selected. A project opportunity may be a potential project for the hypothetical international business services company that a salesman believes to be imminent. The salesman may assign a percentage to the potential project to describe the likelihood that the project will be selected. The project opportunity being selected may be, for example, a project that is contracted and performed by the international business service company. In one embodiment, project data includes a number of jobs required by the project opportunity, a duration for a job required by the project opportunity, a set of skills associated with a job of the project opportunity, and so on.

System 400 may also include a workforce data logic 420 to receive a workforce data 425. The workforce data 425 includes a workforce demand of the project opportunity. In one embodiment, the workforce data 425 includes a probability data that describes the likelihood of employee attrition.

System 400 may also include a constraint logic 430 to receive a set of constraints 435 that include, for example, a cost of leaving a current gap associated with a workforce, a cost of leaving a future gap associated with the workforce, a training cost, a hiring cost, a cost of idle excess workforce, a workforce buffer cost, and so on. In one embodiment, the set of constraints 435 includes, for example, a workforce transformation constraint, a workforce buffer capacity constraint, a hiring detail constraint, an employee allocation hierarchy constraint, a job assignment constraint, and so on.

System 400 may also include an objective function logic 440 to solve an objective function that considers, at least in part, the project data 415, the workforce data 425, and the set of constraints 435. The objective function concerns a workforce allocation plan 450. The objective function may be solved to minimize a workforce cost. The objective function may be solved to optimize a tradeoff between labor utilization and project demand fulfillment. In one embodiment, the workforce allocation plan 450 maps employees to jobs according to the length of time employees are associated with a workforce buffer capacity. For example, in one embodiment it may be important to keep employees rotating off the workforce buffer capacity (e.g. bench). Therefore, a lower cost may be assigned to an employee who has been in the workforce buffer than an employee fresh off of a project.

In one embodiment, unlike typical embodiments, the workforce allocation plan 450 is solved for multi-period environments. In one embodiment, establishing the objective function includes establishing a set of costs calibrated to induce a desired behavior of resource allocation. For example, the current period may be more important than future periods. Therefore, to induce project staffing during the current period, costs associated with not staffing positions (e.g. not filling gaps) in the current period would be higher than costs associated with not staffing positions in future periods. The set of costs may include a cost of leaving a current gap, a cost of leaving a future gap, a training cost, a hiring cost, a cost of idle excess workforce, a workforce buffer cost, and so on.

System 400 may also include an output logic 460 to provide the workforce allocation plan 450. The workforce allocation plan 450 may be provided, for example, to a display via a computer communication via an operable connection.

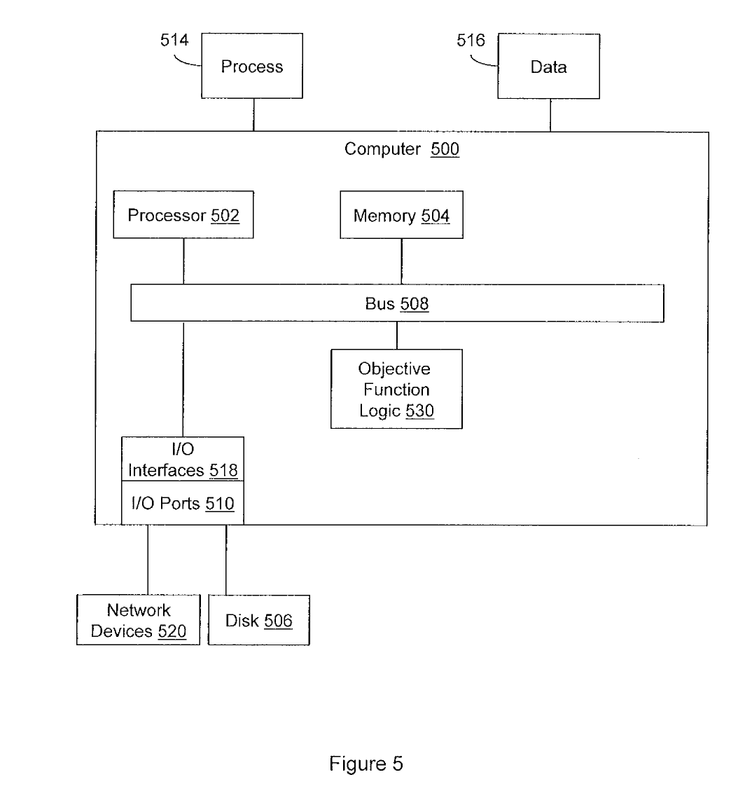

FIG. 5 illustrates an example computing device in which example systems and methods described herein, and equivalents, may operate. The example computing device may be a computer 500 that includes a processor 502, a memory 504, and input/output ports 510 operably connected by a bus 508. In one example, the computer 500 may include an objective function logic 530 to facilitate establishing and calculating an objective function. In different examples, the logic 530 may be implemented in hardware, software, firmware, and/or combinations thereof. While the logic 530 is illustrated as a hardware component attached to the bus 508, it is to be appreciated that in one example, the logic 530 could be implemented in the processor 502.

Thus, logic 530 may provide means (e.g., hardware, software, firmware) for receiving a project data associated with a project opportunity, where the project data includes a probability data, and a workforce demand. The means may be implemented, for example, as an ASIC programmed to solve a workforce planning. The means may also be implemented as computer executable instructions that are presented to computer 500 as data 516 that are temporarily stored in memory 504 and then executed by processor 502.

Logic 530 may also provide means (e.g., hardware, software, firmware) for establishing an objective function that is based, at least in part, on the project data, and a set of constraints. Logic 530 may also provide means (e.g., hardware, software, firmware) for solving the objective function to minimize a workforce cost. The objective function may concern a workforce allocation plan. The objective function may be solved to optimize a tradeoff between labor utilization and project demand fulfillment.

Generally describing an example configuration of the computer 500, the processor 502 may be a variety of various processors including dual microprocessor and other multi-processor architectures. A memory 504 may include volatile memory and/or non-volatile memory. Non-volatile memory may include, for example, ROM, PROM, and so on. Volatile memory may include, for example, RAM, SRAM, DRAM, and so on.

A disk 506 may be operably connected to the computer 500 via, for example, an input/output interface (e.g., card, device) 518 and an input/output port 510. The disk 506 may be, for example, a magnetic disk drive, a solid state disk drive, a floppy disk drive, a tape drive, a Zip drive, a flash memory card, a memory stick, and so on. Furthermore, the disk 506 may be a CD-ROM drive, a CD-R drive, a CD-RW drive, a DVD ROM, and so on. The memory 504 can store a process 514 and/or a data 516, for example. The disk 506 and/or the memory 504 can store an operating system that controls and allocates resources of the computer 500.

The bus 508 may be a single internal bus interconnect architecture and/or other bus or mesh architectures. While a single bus is illustrated, it is to be appreciated that the computer 500 may communicate with various devices, logics, and peripherals using other busses (e.g., PCIE, 1394, USB, Ethernet). The bus 508 can be types including, for example, a memory bus, a memory controller, a peripheral bus, an external bus, a crossbar switch, and/or a local bus.

The computer 500 may interact with input/output devices via the i/o interfaces 518 and the input/output ports 510. Input/output devices may be, for example, a keyboard, a microphone, a pointing and selection device, cameras, video cards, displays, the disk 506, the network devices 520, and so on. The input/output ports 510 may include, for example, serial ports, parallel ports, and USB ports.

The computer 500 can operate in a network environment and thus may be connected to the network devices 520 via the i/o interfaces 518, and/or the i/o ports 510. Through the network devices 520, the computer 500 may interact with a network. Through the network, the computer 500 may be logically connected to remote computers. Networks with which the computer 500 may interact include, but are not limited to, a LAN, a WAN, and other networks.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, the invention is not limited to the specific details, the representative apparatus, and illustrative examples shown and described. Thus, this application is intended to embrace alterations, modifications, and variations that fall within the scope of the appended claims.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

To the extent that the phrase “one or more of, A, B, and C” is employed herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be employed.

What is claimed is:

1. A computer-readable medium storing computer-executable instructions that when executed by a computer cause the computer to perform a method, the method comprising:
receiving a project data associated with a project opportunity, where the project data includes a probability data, where the probability data describes the likelihood of a project opportunity being selected, and where the project data includes a workforce demand;
establishing an objective function that is based, at least in part, on the project data, and a set of constraints, where the objective function concerns a workforce allocation plan;
minimizing a workforce cost by solving the objective function in light of the set of constraints, where solving the objective function includes optimizing a tradeoff between labor utilization and project demand fulfillment; and
providing the workforce allocation plan.

2. The computer-readable medium of claim 1, where the project data includes a number of jobs required by the project opportunity, a duration for a job required by the project opportunity, a probability data that describes the likelihood of employee attrition, and a set of skills associated with a job of the project opportunity.

3. The computer-readable medium of claim 2, where the set of skills includes a job management level, a job proficiency, an industry type, a job skill set, a job role, and a job title.

4. The computer-readable medium of claim 2, where the workforce allocation plan maps employees to jobs according to one or more of, by project opportunities, and by the length of time employees are associated with a workforce buffer capacity.

5. The computer-readable medium of claim 4, where minimizing the workforce cost includes assigning a cost in the workforce buffer capacity, where the cost is directly proportional to the time an employee has been associated with the workforce buffer capacity.

6. The computer-readable medium of claim 4, where the workforce allocation plan includes a labor transformation plan and a labor procurement plan, where the labor transformation plan includes data concerning training, data concerning promotions, and data concerning re-deployment, where the labor transformation plan includes data associated with a lead time for training an employee to attain the job skill set, and where the labor procurement plan includes data associated with a hiring lead time for a job title.

7. The computer-readable medium of claim 1, where minimizing the workforce cost includes one or more of, calculating the workforce allocation plan for multi-period environments, and assigning a first, higher cost to a labor shortage, and assigning a second, lower cost to a labor oversupply.

8. The computer-readable medium of claim 1, the method including:
calculating a workforce buffer capacity for dealing with supply and demand uncertainty of project opportunities, where the workforce buffer capacity varies based, at least in part, on uncertainty associated with project opportunities.

9. The computer-readable medium of claim 1, where the set of constraints includes one or more of, a workforce transformation constraint, a workforce buffer capacity constraint, a hiring detail constraint, an employee allocation hierarchy constraint, and a job assignment constraint.

10. The computer-readable medium of claim 1, where establishing the objective function includes establishing a set of costs calibrated to induce a desired resource allocation behavior, where the set of costs include a cost of leaving a current gap, a cost of leaving a future gap, a training cost, a hiring cost, a cost of idle excess workforce, and a workforce buffer cost, and where the objective function may trigger a workface transformation based on a project that demands labor.

11. A method, comprising:
selecting an active opportunity from a set of opportunities, where the active opportunity is associated with a project opportunity;
preparing an objective function to calculate a minimum cost for a workforce, where the objective function is solvable to optimize a tradeoff between labor utilization and project demand fulfillment;
preparing a set of constraints for the objective function, where the constraints include a cost of leaving a current gap, a cost of leaving a future gap, a training cost, a hiring cost, a cost of idle excess workforce, and a workforce buffer cost; and
solving the objective function for the active opportunity using a mixed integer programming (MIP) approach, as controlled by the set of constraints.

12. A system comprising:
a project data logic to receive a project data associated with a project opportunity, where the project data includes a probability data that describes the likelihood of the project opportunity being selected;
a workforce data logic to receive a workforce data, where the workforce data includes a workforce demand of the project opportunity, and where the workforce data includes a probability data that describes the likelihood of employee attrition;
a constraint logic to receive a set of constraints that include at least one of, a cost of leaving a current gap associated with a workforce, a cost of leaving a future gap associated with the workforce, a training cost, a hiring cost, a cost of idle excess workforce, and a workforce buffer cost;
an objective function logic to solve an objective function that is based, at least in part, on the project data, the workforce data, and the set of constraints, where the objective function concerns a workforce allocation plan, where the objective function is solved to minimize a workforce cost, where the objective function is solved to optimize a tradeoff between labor utilization and project demand fulfillment, and where the workforce allocation plan is solved for multi-period environments; and
an output logic to provide the workforce allocation plan.

13. The system of claim 12, where the project data includes one or more of, a number of jobs required by the project opportunity, a duration for a job required by the project opportunity, and a set of skills associated with a job of the project opportunity, and where the set of constraints includes one or more of, a workforce transformation constraint, a workforce buffer capacity constraint, a hiring detail constraint, an employee allocation hierarchy constraint, and a job assignment constraint.

14. The system of claim 13, where the workforce allocation plan maps employees to jobs according to the length of time employees are associated with a workforce buffer capacity.

15. The system of claim 14, where the objective function considers a set of costs calibrated to induce a desired behavior of resource allocation, where the set of costs include a cost of leaving a current gap, a cost of leaving a future gap, a training cost, a hiring cost, a cost of idle excess workforce, and a workforce buffer cost.
